(19) United States
(12) Patent Application Publication
(10) Pub. No.: US 2018/0182169 A1
(43) Pub. Date: Jun. 28, 2018

(54) MARKER FOR AUGMENTED REALITY EMPLOYING A TRACKABLE MARKER TEMPLATE

(71) Applicant: Atlatl Software, Inc., Charleston, SC (US)

(72) Inventors: Mark Joseph PETRO, Ladson, SC (US); Jeremy Paul BATTS, Johns Island, SC (US)

(21) Appl. No.: 15/388,731

(22) Filed: Dec. 22, 2016

(51) Int. Cl. G06T 19/00; G06K 7/14

(52) U.S. Cl. CPC G06T 19/006; G06K 7/1452; G06K 7/1417

(57) ABSTRACT

A marker is provided for use in an augmented reality (AR) environment. The marker includes a trackable marker template and a content identification block. The trackable marker template may contain heterogeneous graphical content. The trackable marker template may form the border of the marker and encompass the content identification block. The content identification block may hold an encoding of an identifier for some content. The identifier may be used to retrieve content and display a virtual object in the AR environment.

### BACKGROUND OF THE INVENTION

Augmented reality provides a view of a real world scene with elements that are supplemented by computer generated virtual objects. Thus, for example, with an augmented reality system, a user may view a real world scene captured by a camera that is supplemented by one or more virtual objects that are computer generated.

Augmented reality systems may deploy markers or may be markerless. One variety of marker is a fiducial marker, which is an object placed in the field of view of an imaging system for use as a point of reference. Such marker may be located in an image and processed. A virtual object may be then placed into the scene on top of the marker.

### SUMMARY OF THE INVENTION

In accordance with one or more exemplary embodiments, a method is performed in a computing device having one or more processors. In accordance with this method, an image of a real world scene is processed with the one or more processors to locate a marker. The marker includes a marker template containing heterogeneous graphical content and a content identification area holding an encoding of content identification. The marker template surrounds the content identification area. The marker template also forms a border of the marker. Content that is encoded by the content identification in the encoding held in the content identification area is retrieved. This retrieved content is used to display at least one virtual object in the image of the real world scene. The at least one virtual object is displayed over the marker.

In accordance with one or more exemplary embodiments, a method is performed in a computing device having one or more processors. Content for a first virtual object and content for a second virtual object are stored in a storage. At least one image is processed with the one or more processors. This processing comprises locating a first marker in the at least one image. The first marker has a marker template containing heterogeneous graphical content and first content identification identifying content associated with the first virtual object. A second marker is located in the at least one image having the marker template and second content identification that identifies second content associated with the second virtual object. The first marker is processed to retrieve content for the first virtual object and the second marker is processed to retrieve the content of the second virtual object. The first virtual object is displayed over the first marker and the second virtual object is displayed over the second marker in the at least one image on a display device.

In accordance with one or more exemplary embodiments, a method is performed in a computing device having one or more processors wherein a written quote is produced for a product. An augmented reality marker is included on the written quote. The marker includes information about a virtual object that depicts the product. The image of the written quote is processed to locate the marker and process the marker. In response to processing the marker, the virtual object is overlaid over the marker to display the depiction of the product in the image of the written quote.

### BRIEF DESCRIPTION OF THE DRAWINGS

FIG. 1 depicts an exemplary marker for use in an augmented reality environment in accordance with exemplary embodiments described herein.

FIG. 2 depicts the components of the exemplary marker of FIG. 1.

FIG. 3A depicts an image of a real world scene that includes a marker.

FIG. 3B depicts an image of a real world scene in which a virtual object is overlaid where the marker was positioned.

FIG. 4 is a flowchart providing an overview of the steps performed to use a marker in exemplary embodiments described herein.

FIG. 5A depicts an instance in which multiple markers having a same trackable marker template are deployed in a single scene.

FIG. 5B depicts the scene of FIG. 5A wherein virtual objects are displayed over the respective markers.

FIG. 6A depicts an example in which markers having a same trackable marker template are deployed in different scenes.

FIG. 6B depicts an example wherein the markers of FIG. 6A have been overlaid with respective virtual objects in respective scenes.

FIG. 7 is a flowchart illustrating the steps that are performed when multiple markers are used.

FIG. 8A is a flowchart depicting the steps performed when markers are used in conjunction with a written quote.

FIG. 8B shows an example of an image wherein the written quote contains a marker.

FIG. 8C shows an example wherein a virtual object is overlaid over the written quote of FIG. 8B.

FIG. 9 depicts components that are suitable for practicing exemplary embodiments of the present invention.

### DETAILED DESCRIPTION OF THE INVENTION

One of the problems with conventional markers for use in augmented reality environments is that each marker is mapped to a particular encoding. Thus, there is the need to maintain databases for the markers to map to the encodings. The exemplary embodiments eliminate the need for maintaining a database of markers. Instead, a common trackable marker template may be used with different content identification blocks. The content identification blocks may take many different forms, but one suitable form is a 2D barcode that identifies the content associated with the marker. Thus, the markers may all have the same trackable marker template and only the 2D barcodes may change among the markers. Therefore, there is no need for maintaining a database of markers.

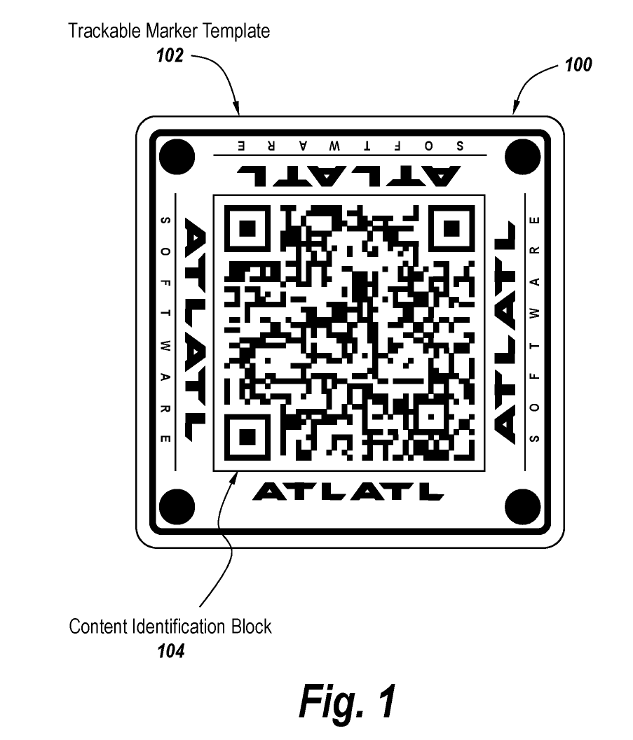

FIG. 1 shows an example of a suitable marker 100. The marker 100 has a trackable marker template 102 that forms the border of the marker and encompasses the content identification block 104. In the example shown in FIG. 1, the content identification block 104 holds a 2D barcode, such as a QR code. Those skilled in the art will appreciate that different encodings may be deployed within the content identification block. The trackable marker template 102 holds heterogeneous graphical content and may be used for multiple markers. Thus, an organization may deploy a common marker that identifies the organization for all markers used in augmented reality environments. The trackable marker template 102 should contain content that makes it readably trackable. The trackable marker template 102 may also contain brand identity information or information for tracking the template.

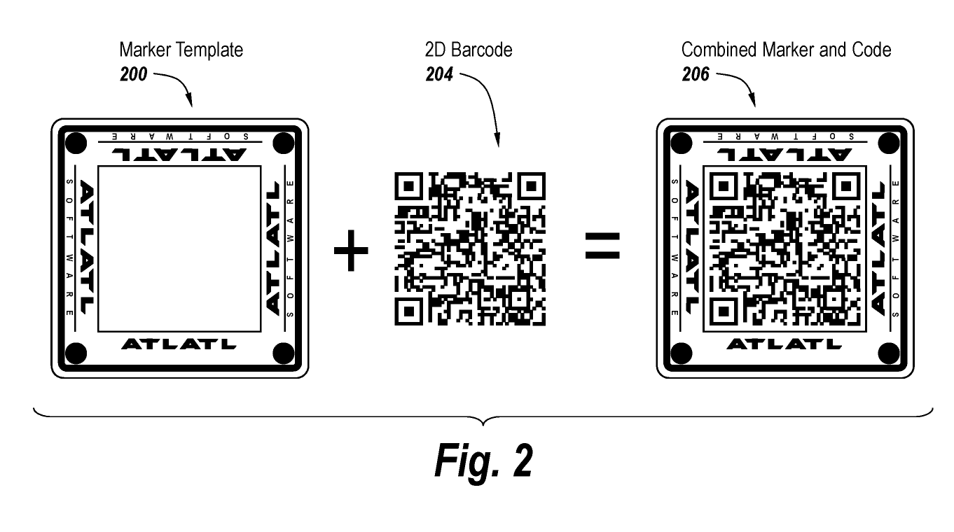

FIG. 2 shows an example of the various components for a template. The marker template 200 is combined with a 2D barcode 204 to produce the combined marker and code (i.e., the “marker”) 206. As was mentioned above, the same marker template 200 may be used with other 2D barcodes to create other markers.

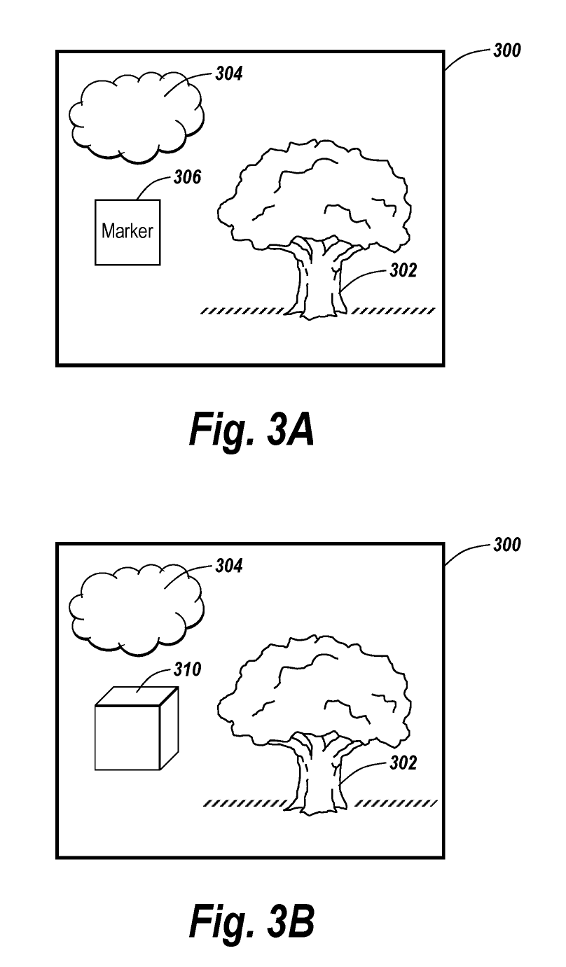

FIG. 3A shows an example of a real world scene and how markers may be used to place virtual objects in a real world scene. As shown in FIG. 3A, an image 300 depicts the real world scene that includes real world elements, such a tree 302 and a cloud 304. The scene also includes a marker 306, such as the marker described herein for exemplary embodiments. The marker 306 may be attached to a document or another object that may be imaged within the real world scene. As shown in FIG. 3B, once the marker 306 has been located and processed, a virtual object 310 may be overlaid on top of the marker 306 to supplement the real world scene. The marker identifies the location of where the virtual object 310 is to be overlaid. Moreover, the marker may be used to identify the pose of the camera and then appropriately orient the virtual object 310 relative to that pose.

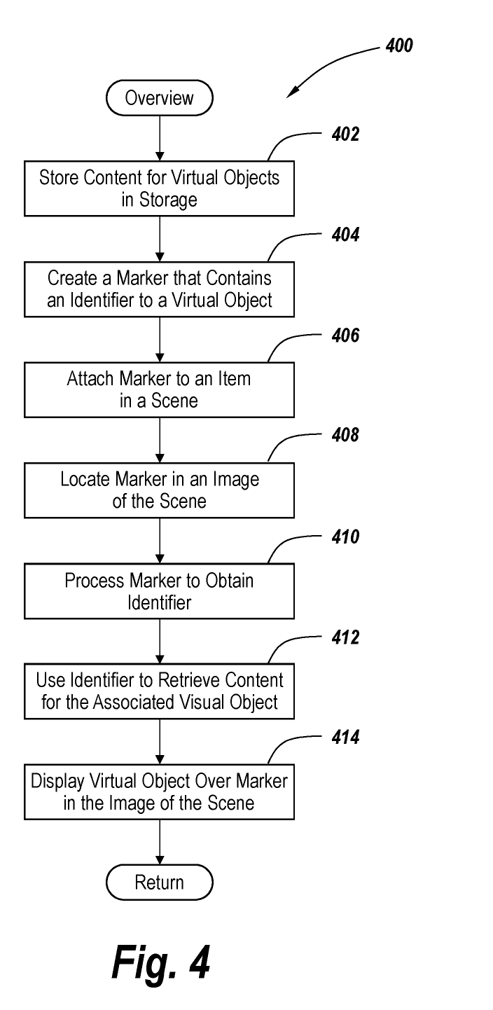

FIG. 4 depicts a flowchart 400 that provides an overview of steps performed in exemplary embodiments. Content for virtual objects that may be deployed in augmented reality environments are stored in storage (step 402). These virtual objects may take different forms, such as content stored in graphical files or, for example, as computer aided design (CAD) models. This content may be indexed by identifiers. These identifiers may be contained within the barcode to specify the content to be rendered on top of the markers.

In step 404, a marker is created that contains an identifier to a virtual object. The identifier is not limited to a singular virtual object but may be associated with a set of virtual objects in some embodiments. In the exemplary embodiments, the marker takes the form such as that depicted in FIG. 1. In step 406, the marker is attached to an item in a scene. Thus a marker, like that depicted in FIG. 1, is attached to an item in a scene, and an image of the scene may be captured, such as by a camera.

The image is processed such that the marker is located in an image of the scene in step 408. There are well known techniques for locating a marker within the scene. Typically these entail segmenting the image and looking for items having the shape and characteristics of a marker. The orientation of the marker relative to the camera is determined to locate the pose of the camera. As was discussed above, this information is used to appropriately position the virtual objects when they are overlaid on the display.

The marker is processed to obtain the identifier for the content in step 410. In the case where a marker like that depicted in FIG. 1 is used, the 2D barcode encodes the identifier and the processing entails reading the 2D barcode to extract the identifier. The identifier is used to retrieve content for the associated virtual object or objects in step 412. As was mentioned above, this content may be stored in storage. In step 414, the virtual object is displayed over the marker in the image of the scene. The display is oriented to conform to the position of the camera that captured the image.

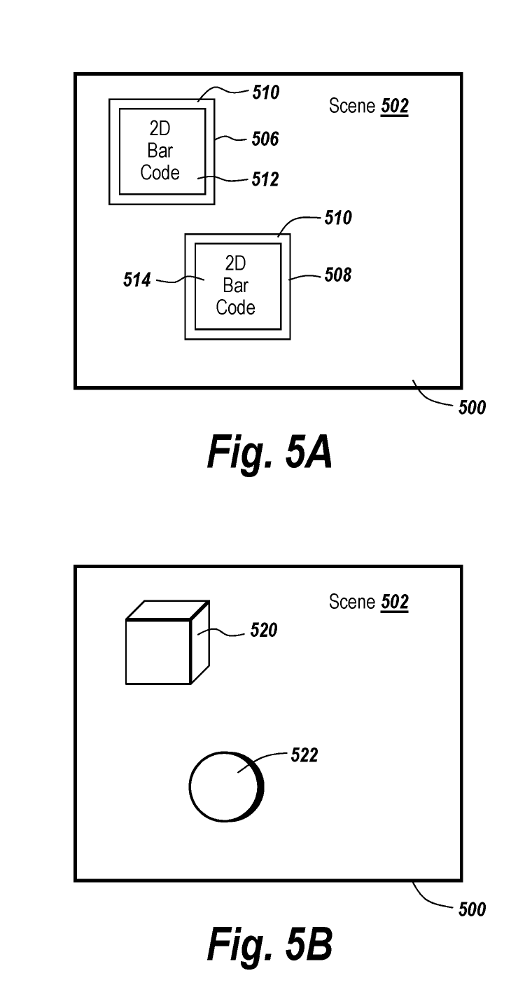

One of the advantages of the marker of exemplary embodiments is that a common trackable marker template may be used for multiple markers. FIG. 5A shows an example in which an image 500 captures a scene 502 that includes markers 506 and 508. Markers 506 and 508 contain the same trackable marker template 510, but different 2D barcodes 512 and 514. The 2D barcodes 512 and 514 encode different identifiers associated with different virtual objects. Thus, when the markers 506 and 508 are processed, different virtual objects 520 and 522 (see FIG. 5B) are overlaid in the scene 502.

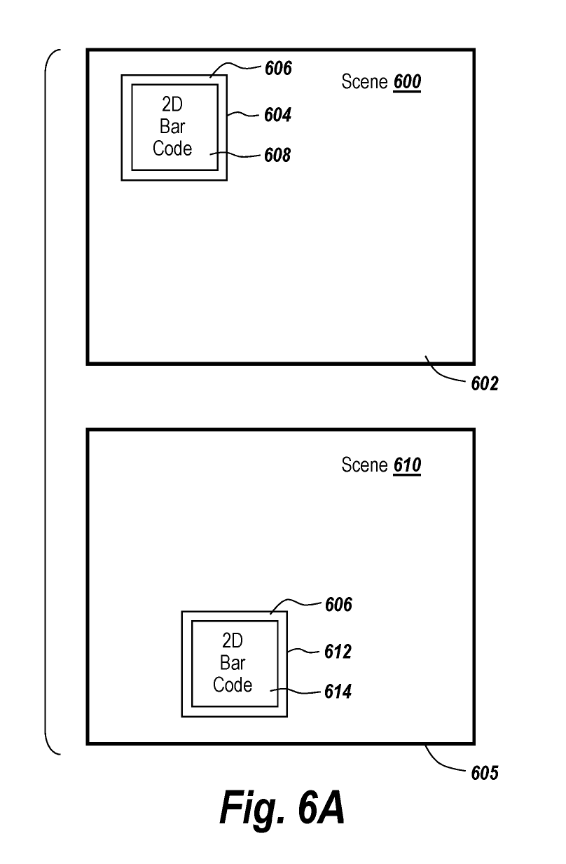

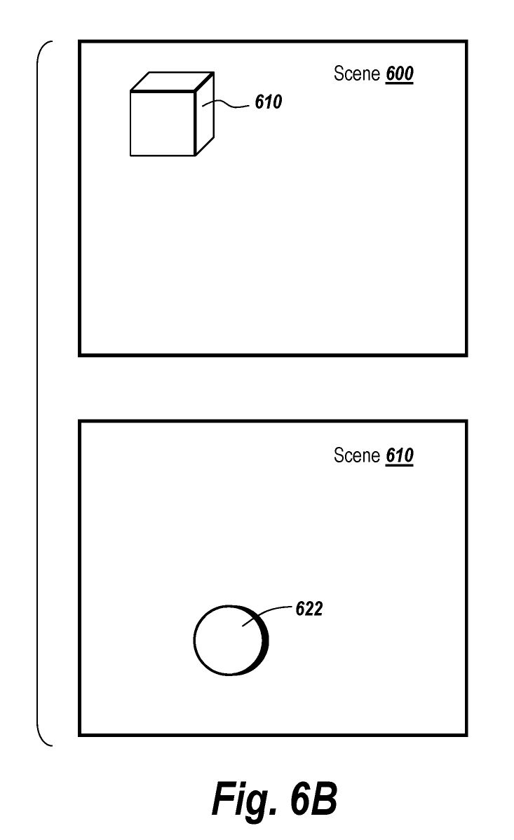

The use of the common trackable marker template is not limited to a single scene, rather markers having the same trackable marker template may be used in different scenes. As shown in FIG. 6A, image 602 of scene 600 includes marker 604. This marker includes trackable marker template 206 and a 2D barcode 608. Image 605 includes a scene 610 that includes a marker 612. The marker 612 has the same trackable marker template 606 as the marker 604 in scene 600, but contains a different 2D barcode 614. Thus, as shown in FIG. 6B, when the markers 604 and 612 are processed, virtual object 620 is overlaid over marker 604 in scene 600, whereas virtual object 622 is overlaid in scene 610.

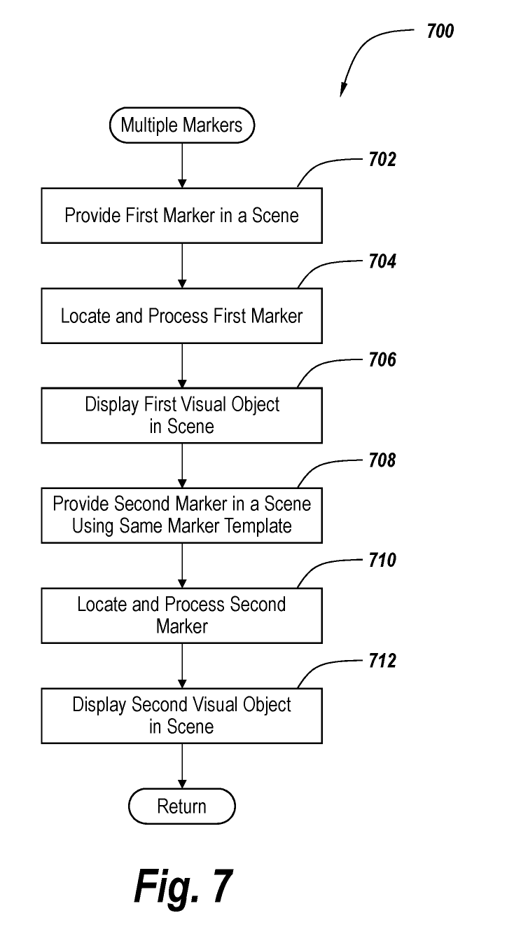

FIG. 7 provides a flowchart of the steps that are performed when multiple markers are used with a common trackable marker template. Initially, a first marker is provided in the scene 702. The first marker is located and processed in step 704. As a result, a first virtual object is displayed in the scene (step 706). A second marker is provided in the scene. The second marker uses the same trackable marker template as the first marker (step 708). The second marker is located and processed in step 710, and a second virtual object is displayed in the scene in step 712. This scene may be the same as the scene that included the first marker or may be a different scene.

One application of the markers is in a software quote system. Software quote systems allow parties to present and manage quotes to potential customers. The quotes may include a price and terms for a sale. Through the use of markers, the quote may also include a virtual display of the product and for other information that a potential customer may review and potentially manipulate, depending on the nature of the display.

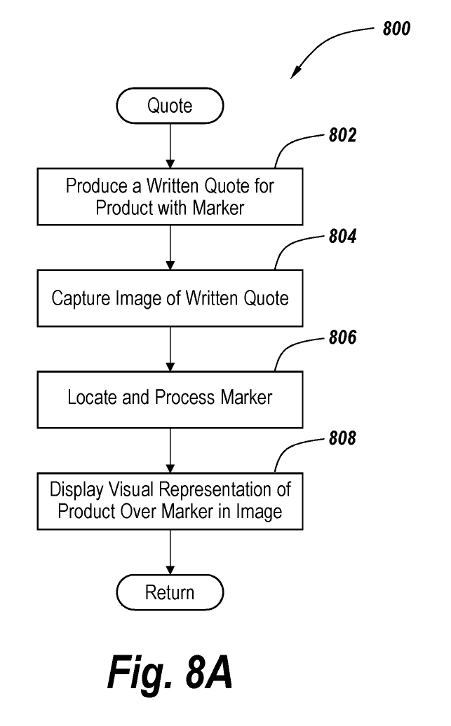

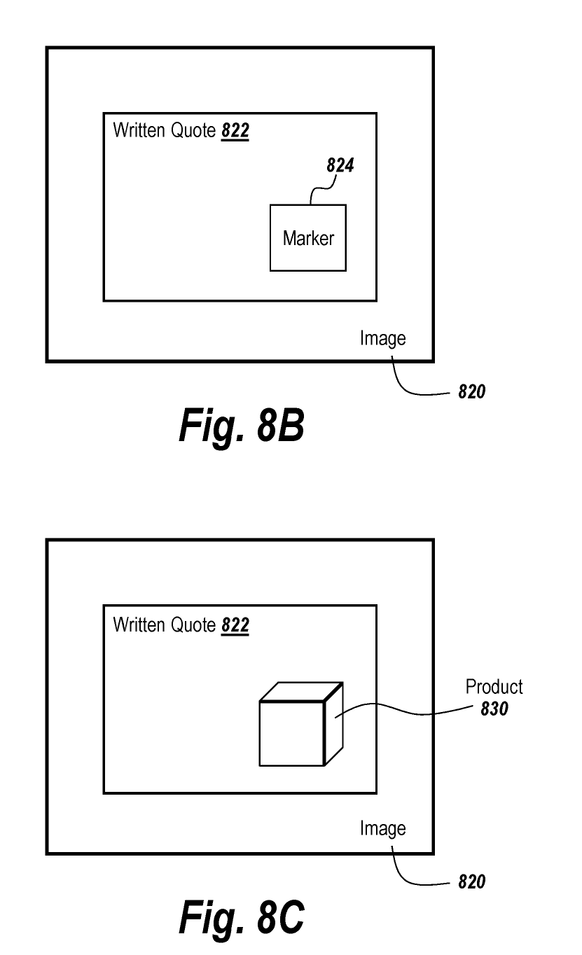

FIG. 8A provides a flowchart 800 of steps that are performed in such a quote application. Initially, a written quote is provided for a product. This written quote includes a marker (step 802). In exemplary embodiments, the marker is like that depicted in FIG. 1. The customer may then capture an image of the written quote, such as by taking a picture of the written quote using a cell phone or other image capture device (step 804). The resulting image may be processed to locate and process the marker (step 806). A virtual representation of the product may then be displayed over the marker in the image (step 808).

FIG. 8B shows an example wherein an image 820 includes a written quote 822 that has a marker 824. Once the marker 824 is fully processed, a virtual display 830 of the product may be incorporated into the image 820 as shown in FIG. 8C. In cases where the product 830 reflects a CAD model, the user may be able to manipulate the image, such as to rotate the image, zoom in and zoom out relative to the image, and perform other functionality that is typically associated with a CAD model. In some applications, the CAD model may even be simulatable so that an associated simulation of the CAD model may be performed. This will require that the execution environment for the CAD model is accessible to perform the simulation.

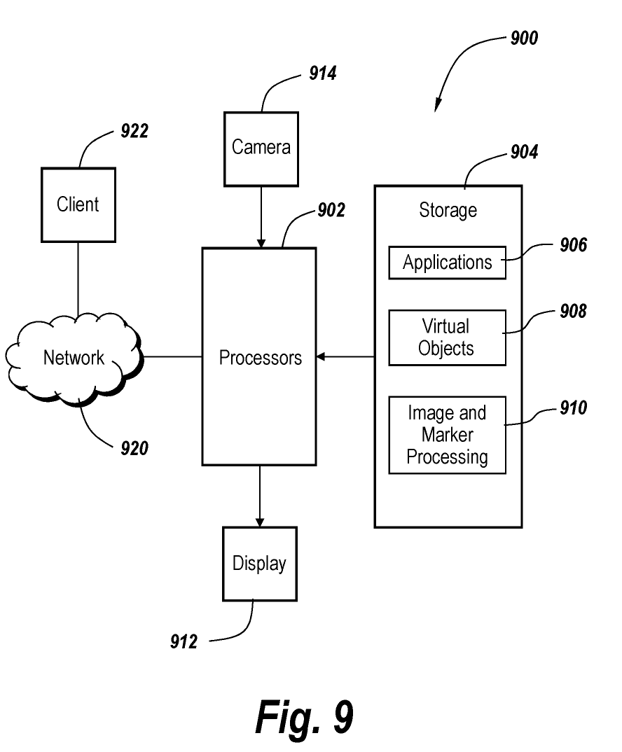

FIG. 9 depicts an example of components that are suitable for execution of the exemplary embodiments. The components are part of a computing device 900 that includes one or more processors 902. These processors may constitute separate microprocessors or multicore processors. The processors 902 may also take the form of specialized processors, such as graphical processing units (GPUs), application specific integrated circuits (ASICs) or field programmable arrays (FTGAs). The processors 902 are responsible for executing instructions stored in storage 904 to perform the functionality described herein. In particular, the processors 902 may execute applications 906 to perform the functionality described herein. Application 906 may rely upon image and marker processing instructions 910 that perform the image processing and the marker processing that is necessary to realize the functionality of the exemplary embodiments. The storage 904 may hold virtual objects 908 that are to be overlaid to realize the augmented reality behavior described above. The storage 904 may include multiple types of storage devices, including optical disc storage, hard disc storage, solid state storage, flash storage, DRAM storage and computer readable media.

The processors 902 may interface with the camera 914 that captures images. The processors 902 may also display content on a display device 912. The display device 912 may take many forms. The computing device 900 may interface with the network 920, such as a local area network, a wide area network like the Internet. A client 922 may be connected to the network 920 and may request services of the computing device 900. Thus, the client could capture the image of a real world scene that includes a marker and then pass the image to the computing device 900 over the network 920 to have the image and marker processed where the resulting augmented reality image is returned to the client 922.

Those skilled in the art will appreciate that various changes and form may be made to the present invention without departing from the intended scope as defined in the appended claims.

1. A method performed in a computing device having one or more processors, comprising:
processing an image of a real world scene with the one or more processors to locate a marker in the real world scene, the marker including:
a marker template containing heterogeneous graphical content;
a content identification application holding an encoding of content identification;
wherein the marker template surrounds the content identification area and forms a border of the marker;
retrieving from a storage content that is encoded by the content identification in the encoding held in the content identification area; and
displaying at least one virtual object in the real world scene based on the retrieved content, the at least one virtual object being displayed over the marker.

2. The method of claim 1 wherein the encoding is a bar code.

3. The method of claim 2 wherein the bar code is a two dimensional bar code.

4. The method of claim 1 wherein the marker is rectangular shaped.

5. The method of claim 1 wherein the content identification area is rectangular.

6. The method of claim 2 wherein the method further comprises:
reading the bar code to obtain a content identifier; and
using the content identifier for the retrieving of the content.

7. A non-transitory computer-readable storage medium holding instructions that when executed cause one or more processors to perform the following:
processing an image of a real world scene with the one or more processors to locate a marker in the real world scene, the marker including:
a marker template containing heterogeneous graphical content;
a content identification application holding an encoding of content identification;
wherein the marker template surrounds the content identification area and forms a border of the marker;
retrieving from a storage content that is encoded by the content identification in the encoding held in the content identification area; and
displaying at least one virtual object in the real world scene based on the retrieved content, the at least one virtual object being displayed over the marker.

8. The non-transitory computer readable storage medium of claim 7 wherein the content identification area holds a bar code.

9. The non-transitory computer readable storage medium of claim 7 wherein the bar code is a two-dimensional bar code.

10. A method performed in a computing device having one or more processors comprising:
processing at least one image with the one or more processors, wherein the processing comprises:
locating a first marker in the at least one image having a marker template containing heterogeneous graphical content and first content identification identifying content associated with a first virtual object, wherein the marker template surrounds the first content identification and forms a border of the first marker;
locating a second marker in the at least one image having the marker template and second content identification identifying second content associated with a second virtual object, wherein the marker surrounds the second content identification and forms a border of the second marker;
processing the first marker to retrieve the content for the first virtual object from storage; and
displaying the first virtual object over the first marker and second virtual object over the second marker in the at least one image on a display device.

11. The method of claim 1 wherein the heterogeneous graphical content of the marker template includes graphical depictions of characters.

12. The method of claim 1, wherein the first content identifier is a bar code.

13. The method of claim 12 wherein the second content identification is a second bar code that differs from the first bar code.

14. The method of claim 10 wherein the first virtual object is a graphical object.

15. The method of claim 10 further comprising storing the first virtual object and the second virtual object in the storage.

16. The method of claim 10 wherein the first marker and the second marker are in a same image of the at least one images.

17. The method of claim 10 wherein the first marker and the second marker are in a different image of the at least one image.

18. A non-transitory computer-readable storage medium holding instructions that when executed cause one or more processors to perform the following:
processing at least one image with the one or more processors, wherein the processing comprises:
locating a first marker in the at least one image having a marker template containing heterogeneous graphical content and first content identification identifying content associated with a first virtual object wherein the marker template surrounds the first content identification and forms a border of the first marker;
locating a second marker in the at least one image having the marker template and second content identification identifying second content associated with a second virtual object wherein the marker template surrounds the second content identification and forms a border of the second marker;
processing the first marker to retrieve the content for the first virtual object from storage; and
displaying the first virtual object over the first marker and second virtual object over the second marker in the at least one image on a display device.

19. A method performed in a computing device having one or more processors, comprising:
with the one or more processors, producing a written quote for a product;
including an augmented reality marker on the written quote, wherein the marker includes information about a virtual object that depicts the product;
processing an image of the written quote to locate the marker and process the marker; and
in response to processing the marker, overlaying the virtual object over the marker to display the depiction of the product in the image of the written quote.

20. A non-transitory computer-readable storage medium holding instructions that when executed cause one or more processors to perform the following:
with the one or more processors, producing a written quote for a product;
including an augmented reality marker on the written quote, wherein the marker includes information about a virtual object that depicts the product;
processing an image of the written quote to locate the marker and process the marker; and
in response to processing the marker, overlaying the virtual object over the marker to display the depiction of the product in the image of the written quote.
